(19) United States
(12) Patent Application Publication
(10) Pub. No.: US 2010/0224466 A1
(43) Pub. Date: Sep. 9, 2010

(54) Portable handheld work apparatus

(75) Inventors: Klaus Leinmüller, Schwäbisch Gmünd (DE); Lukas Zürcher, Stuttgart (DE); Rolf Walter, Waiblingen (DE)

Correspondence Address: WALTER OTTESEN, PO BOX 4026, GAITHERSBURG, MD, 20885-4026, US

(73) Assignee: Andreas Stihl AG & Co. KG.

(21) Appl. No.: 12/659,280

(22) Filed: Mar. 3, 2010

(30) Foreign Application Priority Data
Mar. 4, 2009 (DE) 10 2009 011 684.2

(51) Int. Cl. H01H 9/00

(52) U.S. Cl. 200/1 B

(57) ABSTRACT

A portable handheld work apparatus has an internal combustion engine (7) which includes an ignition system. An operating-mode position selector (55) is provided which closes a first switch (76) in a first position and closes a second switch (77) in a second position. The first switch (76) includes a first contact (39) and the second switch (77) includes a second contact (40). A simple and robust configuration is provided when the first contact (39) and the second contact (40) are formed on the operating-mode position selector (55).

### CROSS REFERENCE TO RELATED APPLICATION

This application claims priority of German patent application no. 10 2009 011 684.2, filed Mar. 4, 2009, the entire content of which is incorporated herein by reference.

### FIELD OF THE INVENTION

The invention relates to a portable handheld work apparatus having an internal combustion engine and an ignition system.

### BACKGROUND OF THE INVENTION

U.S. Pat. No. 5,209,196 discloses a motor-driven chain saw having an operating-mode position selector with which different positions of the operating-mode position selector can be electrically detected. For this purpose, several contacts are arranged on the housing of the motor-driven chain saw which are connected to each other in dependence upon the position of the operating-mode position selector via the operating-mode position selector.

### SUMMARY OF THE INVENTION

It is an object of the invention to provide a portable handheld work apparatus of the kind described above wherein the operating-mode position selector is assembled in a simple manner and is robust.

The portable handheld work apparatus of the invention includes: an internal combustion engine having an ignition system; a first switch having a first contact; a second switch having a second contact; an operating-mode position selector movable from a first position whereat the first switch is closed to a second position whereat the second switch is closed; and, the first contact and the second contact being configured on the operating-mode position selector.

The contacts are not formed in the housing of the work apparatus but on the operating-mode position selector itself and the contacts are coated with the material of the operating-mode position selector. The contacts are fixedly held to the operating-mode position selector because of the coating of the material thereof. For assembly, no additional work step is needed so that the manufacture of the work apparatus is simplified. At the same time, the contacts stiffen the operating-mode position selector and so increase the stability thereof.

To detect the different positions of the operator-mode position selector, the second contact is electrically connected to the first contact via an electric component. In this way, different electric characteristics result with the contacting of the first and second contacts and these electric characteristics can be detected by a control, especially, a control of the ignition system. Advantageously, the electric component is coated with the material of the operating-mode position selector. In this way, the electric component is protected against contaminants and vibrations.

Advantageously, the first contact, the second contact and the electric component conjointly form a common component which is coated by the material of the operating-mode position selector. The first contact, the second contact and the electric component are advantageously tightly bonded to each other already in advance of the coating with the plastic of the operating-mode position selector and thereby form a tight structure which contributes to the strength of the operating-mode position selector. Because the at least two contacts and the electric component form a common component, the positioning is simplified when placing the component in the injection mold during manufacture of the operating-mode position selector. Only one component need be positioned.

A simple configuration results when at least one contact is configured on a sheet metal piece. The electric component is connected to the sheet metal piece via a bent-over lug formed on the sheet metal piece. In this way, only one bent sheet metal part is needed for forming the contact and for fixing the electric component.

Advantageously, at least one contact is formed on a bolt which is coated with the material of the operating-mode position selector. The bolt has a high stability and can be easily manufactured and contacted.

The operating-mode position selector is advantageously pivotally journalled about a rotational axis on the work apparatus. At least one contact is configured on a conductor which is coated by the material of the operating-mode position selector. Advantageously, the internal combustion engine includes a carburetor. The operating-mode position selector is especially configured as an operator-controlled shaft having an axial length corresponding at least to the width of the carburetor measured parallel to the rotational axis of the operator-controlled shaft. In this way, the operator-controlled lever for the operating-mode position selector and the contacts or elements for actuating the carburetor can be arranged on opposite-lying ends of the carburetor. In order to obtain a high stability of the operator-controlled shaft, the conductor extends approximately over the entire length of the operator-controlled shaft. The conductor stiffens the operator-controlled shaft and thereby not only facilitates the manufacture of an electric connection between the two ends of the operator-controlled shaft but simultaneously also stiffens the operator-controlled shaft. In the region of the first end of the operator-controlled shaft, an operator-controlled lever is arranged and, in the region of the second end of the operator-controlled shaft, the first and second contacts are arranged. Advantageously, in the region of the first end of the operator-controlled shaft, a connector especially for connecting to the ignition system, is arranged. The connector is advantageously configured on the conductor and projects from the material of the operator-controlled shaft. It can also be provided that the connector is a ground connector.

Advantageously, the conductor is fixedly connected to the at least one electric component and to the contacts and forms a carrying structure of the operator-controlled shaft. The conductor, the electric component and the contacts conjointly form a single component which supports the operator-controlled shaft and contributes to increasing the stability thereof. Mechanical forces occur during operation on the operator-controlled shaft, for example, because of the switching of the operator-controlled shaft between the different switch positions. These mechanical forces are not only taken up by the plastic material of the operator-controlled shaft but also by the material of the conductor. Advantageously, the first contact is formed on the conductor itself so that the formation of the first contact requires no additional component.

The conductor is especially a stamped conductor. A stamped conductor is understood to be a sheet metal part which forms conductor paths as well as contacts. A sheet metal part of this kind can be manufactured in a simple manner by stamping from sheet metal and, if needed, by bending into the desired form. The stamped conductor makes possible, in a simple manner, the formation of the connecting lines and contacts or connectors on a single component.

The electric component is advantageously a diode. It can, however, also be provided that the electric component is a resistor. A resistor is especially advantageous when more than two switch positions of the operating-mode position selector are to be detected.

It can be provided that the operating-mode position selector is made at least partially of an electrically-conducting material. The electrically-conducting material can be an electrically-conducting plastic or metal. The operating-mode position selector advantageously comprises, for the most part, electrically-conducting material, especially with the only exception of the operator-controlled lever. The contacts and the conducting connection between the contacts are thereby formed by the conducting material of the operating-mode position selector. Separate contacts or a separate conductor are unnecessary.

It is practical that the switch includes a contact spring which coacts with the contacts. It is advantageous that each switch is formed by the contact spring and a contact of the operating-mode position selector which coacts with this contact spring. The contact spring is connected to ground. Advantageously, the first switch is closed in an off position of the operating-mode position selector. In this position, the ignition system is connected via the contact spring to the ground connector so that no ignition spark can be formed for the internal combustion engine. It can also be provided that the contact spring is connected to the ignition system and the connector, to which the contact is connected, is a ground connector which is connected to ground.

It is provided that the second switch is closed in a choke position of the operating-mode position selector. The choke position or cold-start position can, in this way, be detected by the control electronic of the ignition system. This is so, because of the intermediately switched electric component, different electric characteristics are present than during normal operation. Depending upon the component, current and/or voltage can be lower than during usual operation. In portable handheld work apparatus, it is advantageous to not only provide for a choke position but also a warm-start position from which the work apparatus can be started when there are high ambient temperatures or when the internal combustion engine has already run warm. To be able to detect this position, it is provided that the operating-mode position selector has a third contact which is part of a third switch. The third switch is advantageously closed in a start position, that is, in a warm-start position of the operating-mode position selector. In this way, all positions of the operating-mode position selector can be detected, namely: off position, choke position, start position and operating position. In the operating position, the contact spring coacts with none of the contacts. This too is detected by the control electronics of the ignition system. Advantageously, the third contact is coated by the operating-mode position selector.

### BRIEF DESCRIPTION OF THE DRAWINGS

The invention will now be described with reference to the drawings wherein:

FIG. 1 is a schematic side elevation view of a motor-driven chain saw;

FIG. 2 is a schematic section view of the carburetor of the motor-driven chain saw of FIG. 1;

FIG. 3 is a side elevation view of the carburetor of FIG. 1 with the operator-controlled shaft in the off position;

FIG. 4 is a perspective view of the operator-controlled shaft of FIG. 3;

FIG. 5 is a plan view of the operator-controlled shaft of FIG. 4;

FIG. 6 is a perspective cutaway view of the operator-controlled shaft;

FIG. 7 is a longitudinal section through the operator-controlled shaft;

FIG. 8 is a side elevation view in the direction of arrow VIII in FIG. 7;

FIG. 9 is a side elevation view in the direction of arrow IX in FIG. 7;

FIG. 10 is a section view through the operator-controlled shaft along the line X-X in FIG. 7;

FIG. 11 is a section view through the operator-controlled shaft along line XI-XI in FIG. 7;

FIG. 12 is a section view along line XII-XII in FIG. 7;

FIG. 13 is a perspective view of the stamped conductor of the operator-controlled shaft;

FIG. 14 is a plan view of the stamped conductor of FIG. 13;

FIG. 15 is a side elevation view of the stamped conductor;

FIG. 16 is a section view of an embodiment of the operator-controlled shaft corresponding to the view shown in FIG. 12;

FIG. 17 is a perspective view of an operating-mode position selector;

FIG. 18 is a section view through the operating-mode position selector of FIG. 17;

FIG. 19 is a section view along line XIX-XIX in FIG. 18;

FIG. 20 is a section view along line XX-XX in FIG. 19;

FIG. 21 is a perspective view of the electric component with the contacts of the operating-mode position selector of FIG. 17;

FIG. 22 is a plan view of the contacts with the electric component;

FIG. 23 is a side elevation view taken along arrow XXIII in FIG. 22;

FIGS. 24 to 27 are schematic views of the operating-mode position selector in the different switch positions; and,

FIG. 28 is an embodiment, in section, of an operating-mode position selector.

### DESCRIPTION OF THE PREFERRED EMBODIMENTS OF THE INVENTION

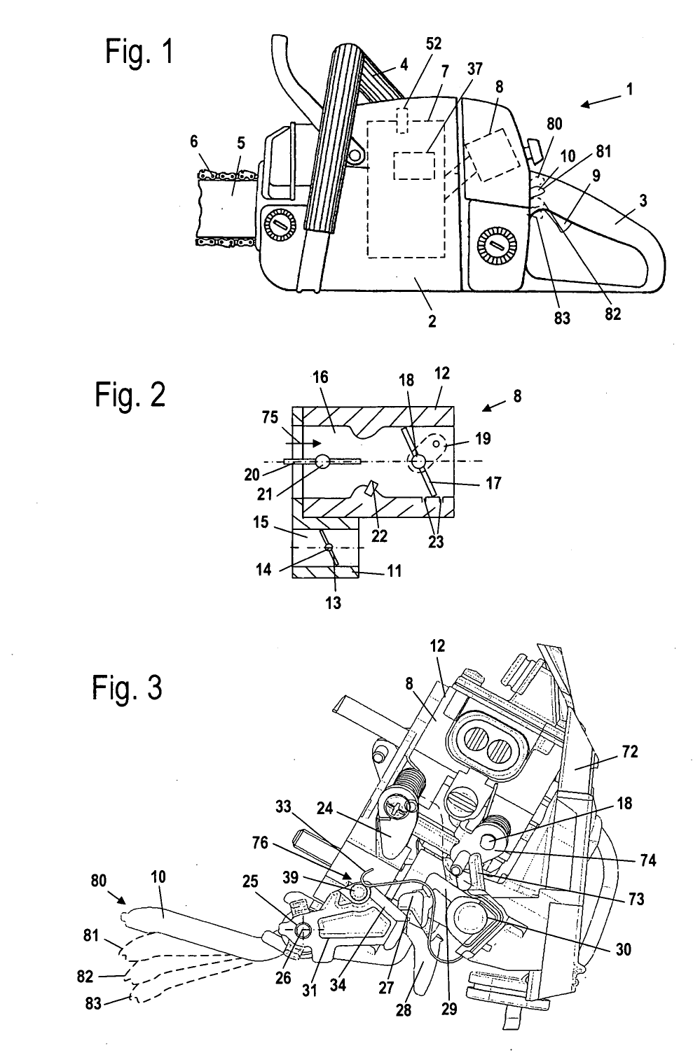

In FIG. 1, a motor-driven chain saw 1 is shown schematically as an embodiment for a portable handheld work apparatus. The portable handheld work apparatus can also be another work apparatus such as a hedge trimmer, brushcutter, cutoff machine or the like. The motor-driven chain saw 1 has a housing 2 on which a rearward handle 3 and a grip tube 4 are fixed. A guide bar 5 projects forward on the end of the housing 2 facing away from the rearward handle 3. A saw chain 6 is driven to run about the periphery of the guide bar. The saw chain 6 is driven by an internal combustion engine 7 which is mounted in the housing 2.

The internal combustion engine 7 has a carburetor 8 via which an air/fuel mixture is drawn in by suction. In the housing 2, an ignition module 37 is also arranged which controls the ignition of the air/fuel mixture in the combustion chamber of the engine 7. For this purpose, a spark plug 52 projects into the combustion chamber of the engine 7. A throttle lever 9 is journalled on the rearward handle 3 to operate the engine 7. An operator-controlled lever 10 projects out from the housing 2 next to the rearward handle 3. With the operator-controlled lever 10, different operating modes of the engine 7 can be set. The operator-controlled lever 10 can be moved by the operator into an off position 80, a choke position 83 and a start position 82. After starting the engine 7, the operator-controlled element 10 is automatically set into an operating position 81.

FIG. 2 schematically shows the carburetor 8. The carburetor 8 includes a carburetor housing 12 and an air channel component 11 which is held on the carburetor housing 12. In the carburetor housing 12, a mixture channel 16 is formed wherein a throttle flap 17 is pivotally journalled with a throttle shaft 18. A throttle lever arm 19 is mounted on the throttle shaft 18 for actuating the throttle flap 17. The throttle lever arm 19 is actuated via the throttle lever 9. Ancillary fuel openings 23 open into the mixture channel 16 in the region of the throttle flap 17. Referred to the flow direction 75 from an air filter (not shown) to the engine 7, a venturi is formed upstream of the throttle flap 17 and a main fuel opening 22 opens into the mixture channel 16 in the region of the venturi. A choke flap 20 having a choke shaft 21 is pivotally journalled in the mixture channel 16 upstream of the venturi.

In the air channel component 11, an air channel 15 is formed wherein an air flap 13 is pivotally journalled with an air flap shaft 14. The movement of the air flap 13 is advantageously coupled to the movement of the throttle flap 17.

A comparatively rich mixture must be supplied to the engine 7 for starting the same. For this purpose, the choke flap 20 and the throttle flap 17 are shifted into a choke position. In the choke position, the choke flap 20 is usually completely closed and the throttle flap 17 is partially closed. In the start position or warm-start position, the choke flap 20 is partially or completely open and the throttle flap 17 is partially closed. These positions of the choke flap 20 and the throttle flap 17 are set via an operating-mode position selector. This is shown in FIG. 3. The operating-mode position selector on which the operator-controlled lever 10 is formed is configured as an operator-controlled shaft 25 and is pivotally journalled about a rotational axis 26.

For actuating the choke flap 20, the operator-controlled shaft 25 has an actuating cam 27 which coacts with a choke lever 24 arranged on the choke shaft 21 so as to rotate therewith. In the off position 80 of the operator-controlled lever 10 shown in FIG. 3, the actuating cam 27 is out of engagement with the choke lever 24. Furthermore, an actuating cam 28 for actuating the throttle flap 17 is provided on the operator-controlled shaft 25. The actuating cam 28 coacts with an actuating section 29 of the intermediate lever 30. The intermediate lever 30 is pivotally journalled on a carburetor carrier 72. The intermediate lever 30 can, however, also be pivotally journalled on the carburetor housing 12. The intermediate lever 30 has a fork 73 which coacts with a lever 74 and so shifts the throttle flap 17 into the desired position. The lever 74 is mounted on the throttle shaft 18 so as to rotate therewith.

A lever 31 is formed as one piece with the operator-controlled shaft 25. The lever 31 has a latch contour 34 on which a contact spring 33 slides. The contact spring 33 is fixed to the carburetor carrier 72. The latch contour 34 is also shown in FIG. 6. The contact spring 33 is connected to ground, for example, to the metal housing of the internal combustion engine 7. In the off position 80 of the operator-controlled shaft 25 shown in FIG. 3, the contact spring 33 lies against a first contact 39 of the operator-controlled shaft 25. The contact spring 33 forms with the first contact 39 a first switch 76. In this switch position, the ignition module 37 is connected to ground via the first switch 76 so that no ignition spark can be generated.

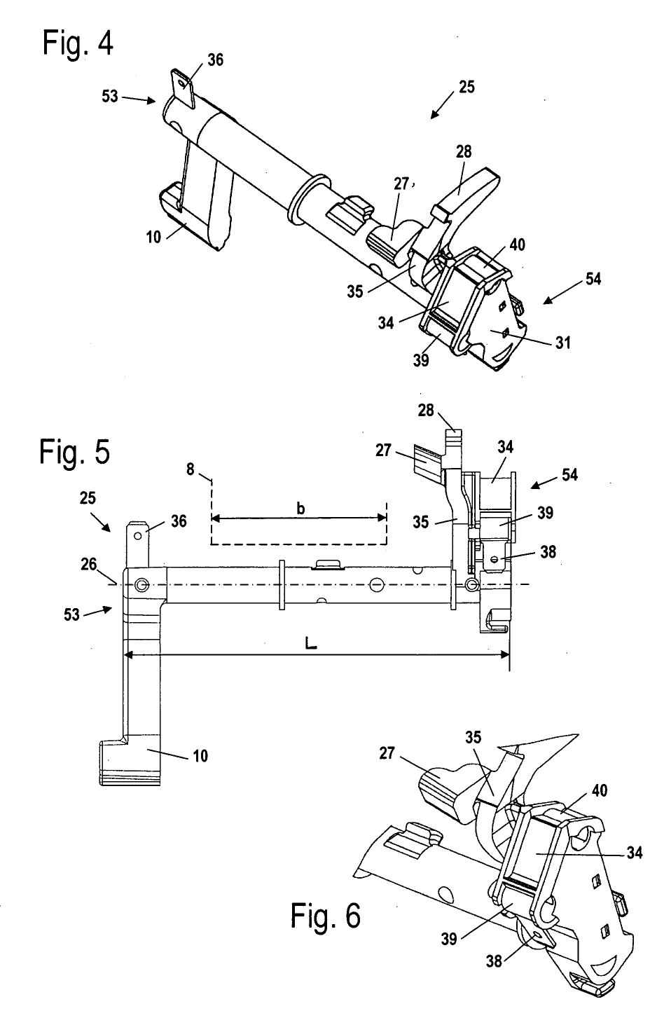

As shown in FIGS. 4 and 5, the actuating cam 27 and the actuating cam 28 are arranged on the actuating lever 35 which is formed on the operator-controlled shaft 25. At a first end 53 of the operator-controlled shaft 25, the operator-controlled lever 10 as well as an ignition module connector 36 are arranged for connecting to the ignition module 37. In lieu of the ignition module connector 36, a connector to a separate control can be provided which evaluates the voltage course at the connector 36 and correspondingly controls the ignition of the engine 7. On the opposite-lying second end 54 of the operator-controlled shaft 25, the lever 31 is mounted on which the first contact 39 as well as a second contact 40 are formed. The contact spring 33 lies in the choke position 83 on the second contact 40.

Because of the shape of the latch contour, the operator-controlled shaft 25 is held by the contact spring 33 in the choke position 83 and in the off position 80. The operator-controlled shaft 25 is fixed by the contact spring 33 also in the operating position 81. In the start position 82, the fixing of the operator-controlled shaft 25 in this position takes place via a latching of the actuating section 29 on the actuating cam 28 (FIG. 3). This latching is released by actuating the throttle lever 9 and therefore by rotating the throttle flap 18 so that the operator-controlled shaft 25 is automatically transferred out of the start position 82 into the operating position 81 with the first actuation of the throttle lever.

As FIG. 5 shows, a connector 38 is formed on the first contact 39. FIG. 5 shows that the operator-controlled shaft 25 has a length L measured in the direction of the rotational axis 26. The carburetor 8 shown schematically in FIG. 5 has a width (b) which is less than the length L of the operator-controlled shaft 25. The width (b) of the carburetor 8 is measured in the direction of the rotational axis 26 of the operator-controlled shaft 25. The ignition module connector 36 and the operator-controlled lever 10 are arranged thereby on one side of the carburetor 8 at the first end 53 of the operator-controlled shaft 25 and the two contacts 39 and 40 as well as the connector 38 are arranged on the second opposite-lying end 54 of the operator-controlled shaft 25 at the opposite-lying side of the carburetor.

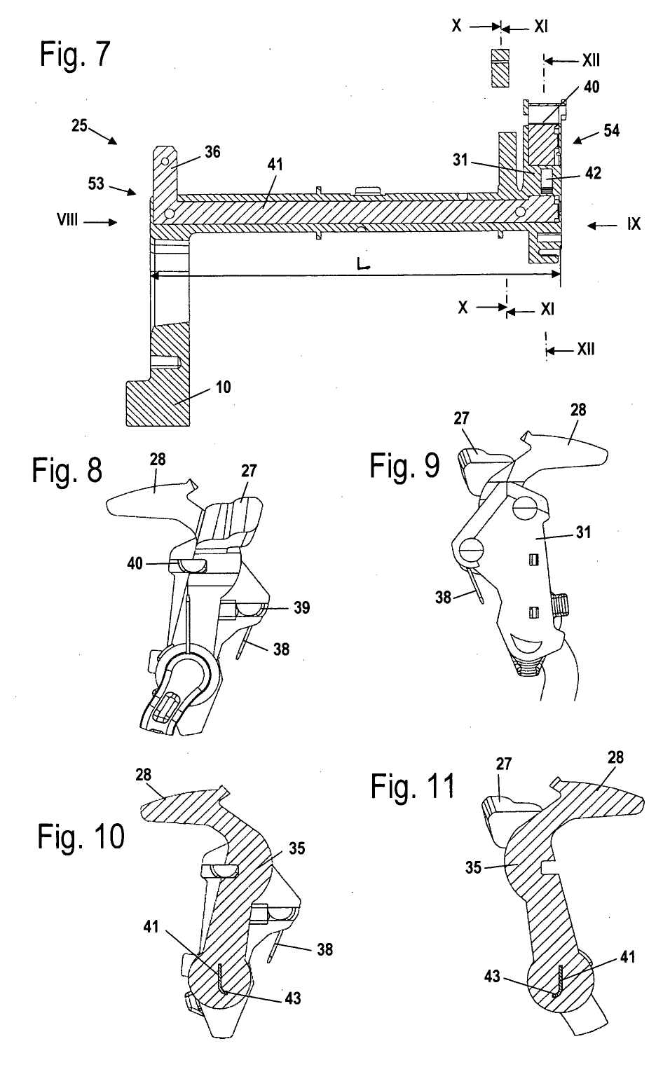

As shown in FIG. 7, the ignition module connector 36 is formed on a stamped conductor 41 which extends over approximately the entire length L of the operator-controlled shaft 25 in the interior thereof. The stamped conductor 41 is coated by the material of the operator-controlled shaft 25. The operator-controlled shaft 25 is made of plastic and the stamped conductor 41 is made of a stamped sheet metal piece which is bent over in the region of the contact 39 and of the connector 38. The contacts (39, 40) project out of the material of the operator-controlled shaft 25 so that contact can be made thereto. The ignition module connector 36 is formed also on the stamped conductor 41. The connector 36 likewise projects out from the material of the operator-controlled shaft 25 so that contact can be made thereto. The arrangement of the stamped conductor 41 in the operator-controlled shaft 25 is also shown in FIGS. 10 and 11.

As FIGS. 10 and 11 show, the stamped conductor 41 has a bent-over edge 43 on its end facing toward the operator-controlled lever 10 and facing away from the actuating cams 27 and 28. The bent-over edge 43 increases the mechanical stability of the stamped conductor 41. At the second end 54, an electric component, namely a diode 42, is coated with the material of the lever 31 via which the second contact 40 is connected to the stamped conductor 41 and, via the stamped conductor 41, to the ignition module connector 36. The stamped conductor 41 is formed from a stamped sheet metal part. A differently configured conductor can be provided in lieu of the stamped conductor 41. In lieu of the diode 42, also another electric component can be provided, namely, an inductance or a capacitance or a combination of inductance and capacitance and resistance.

The arrangement of the contacts 39 and 40 and of the connector 38 is also shown in FIGS. 8 and 9. The contacts (39, 40) are each configured as slotted sleeves and the contact spring 33 comes into contact against the outer side of these sleeves. The connector 38 is arranged on the free end of the contact 39. The stamped conductor 41 with the contacts (36, 39, 40) acts as an electric distributor.

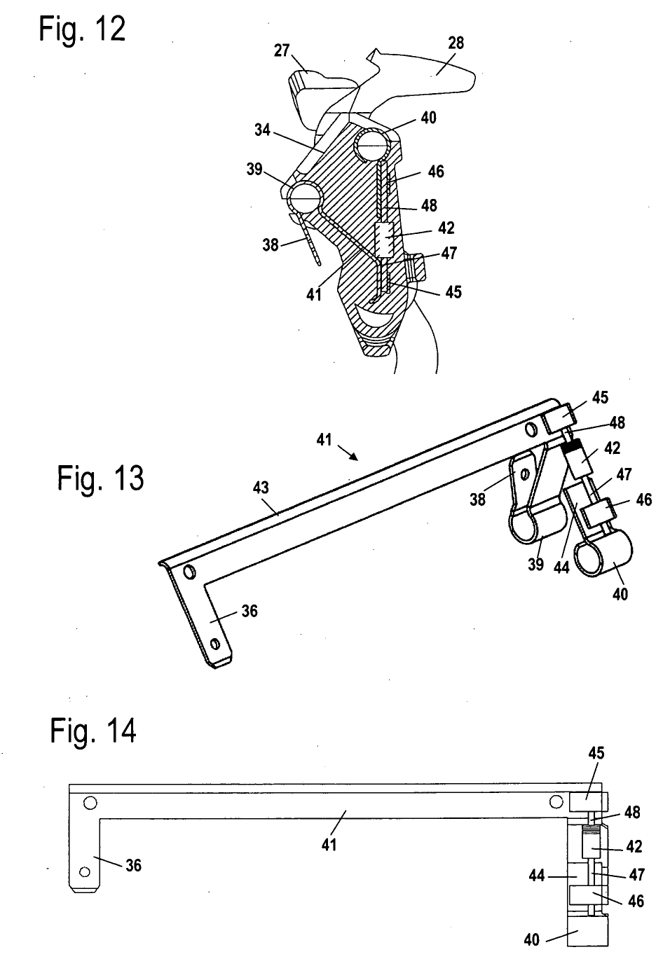

As shown in FIG. 12, the diode 42 has a first connector 47 which is mechanically and electrically connected to the stamped conductor 41 via a lug 45 formed on the stamped conductor 41. The diode 42 has a second connector 48 which is connected mechanically and electrically to the second contact 40 via a lug 46.

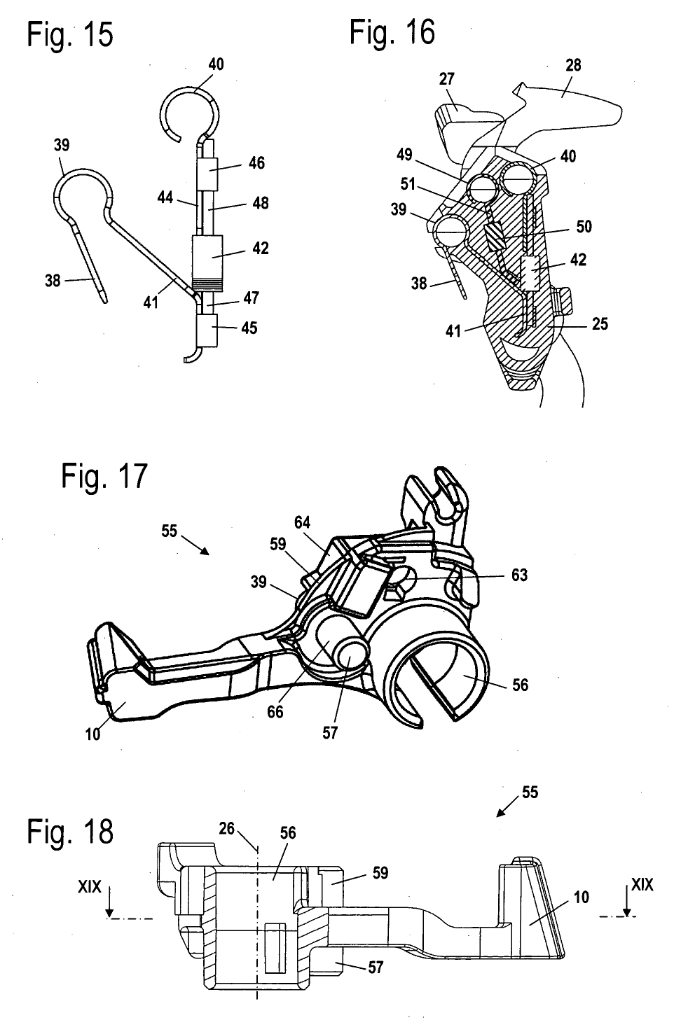

FIGS. 13 to 15 show the shape of the stamped conductor 41 and the contacts 39 and 40 in detail. As FIG. 13 shows, the ignition module connector 36, the first contact 39 and the connector 38 as well as the lug 45 are formed on the stamped conductor 41. These form a common sheet metal bent part. The second contact 40 is configured on a sheet metal piece 44 whereon the lug 46 is also formed for connecting to the first connector 47 of the diode 42. The lugs 45 and 46 are configured as lateral, outwardly projecting and bent over sheet metal flags which force tightly fix the connectors 47 and 48 of the diode 42. The stamped conductor 41 is firmly connected to the diode 42 and the sheet metal piece 44 via the lugs 45 and 46. These parts form a common component which forms a carrying structure of the operator-controlled shaft 25. This carrying structure stiffens the operator-controlled shaft 25 and increases its stability.

FIG. 16 shows an embodiment of the operator-controlled shaft 25 for which a third contact 49 is provided in addition to the first contact 39 and the second contact 40. The third contact 49 comes into engagement with the contact spring 33 in the start position 82. The third contact 49 is connected via a resistance 50 to the stamped conductor 41. The third contact 49 can be formed from sheet metal 51 like the second contact 40 and can be connected to the resistance 50 via a corresponding lug not shown in FIG. 16. The electric characteristics of the resistance 50 and of the diode 42 are so selected that the microprocessor of the ignition module 37 can clearly detect the switch position of the operator-controlled shaft 25 based on the electric signal which is generated in the particular switch position. It can also be advantageous to connect the second contact 40 as well as the third contact 49 to the stamped conductor 41 via different resistances. Other electric components or combinations of electric components can also be advantageous. In lieu of the ignition module 37, a separate control can also be provided which detects the switch positions of the operator-controlled shaft 25 and correspondingly controls the engine 7.

FIGS. 17 to 19 show an embodiment of an operating-mode position selector 55 which is not configured as an operator-controlled shaft but as a pivotable lever. An operator-controlled lever 10 is formed on the operating-mode position selector 55. Actuation cams for actuating the throttle flap 17 and choke flap 20 are not provided on the operating-mode position selector 55. These positions are determined via different units. The operating-mode position selector 55 is comprised of plastic and has a bearing opening 56 at which the operating-mode position selector 55 is pivotally journalled about a rotational axis 26. The operating-mode position selector 55 has a bolt 57 which is injected into the material of the operating-mode position selector 55. The operating-mode position selector 55 comprises plastic and the bolt 57 is made of metal. A wall 59 extends in the longitudinal direction of the operating-mode position selector 55. The wall 59 separates a first contact 39, which is formed on the bolt 57, from an ignition module connector 66 which is likewise formed on the bolt 57. A latch contour 64 is formed on the side of the wall 59 facing toward the first contact 39. A contact spring 33 not shown in FIGS. 17 to 19 slides over the latch contour 64. The contact spring 33 coacts with the contacts of the operating-mode position selector 55. The operating-mode position selector 55 has an opening 63 for a second contact 40.

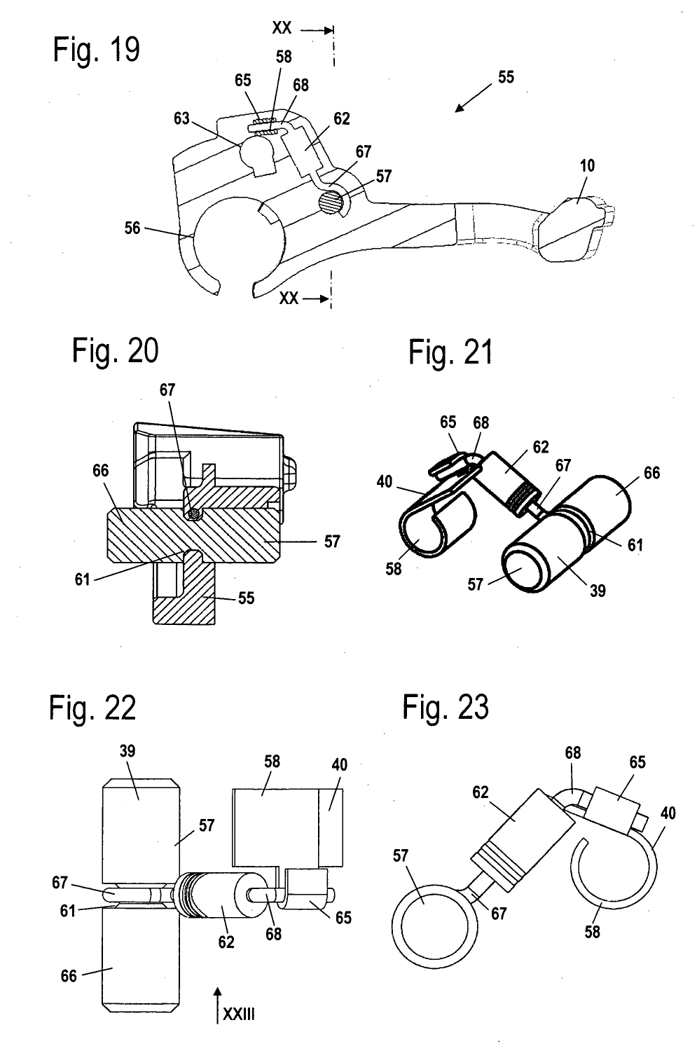

As shown in FIG. 19, the bolt 57 is connected to a sheet metal piece 58 via a diode 62 and the second contact 40 is formed on the sheet metal piece 58 (FIG. 21). As FIG. 19 shows, a first connector 67 of the diode 62 is connected to the bolt 57. FIG. 20 shows that the bolt 57 has a peripherally-extending slot 61 wherein the first connector 67 is arranged.

As FIG. 19 shows, the diode 62 has a second connector 68 which is fixed by a lug 65 of the sheet metal piece 58.

FIGS. 21 to 23 show the bolt 57, the diode 62 and the sheet metal piece 58. These three components form a carrying structure of the operating-mode position selector 55 and stiffen the same. The sheet metal piece 58 is annularly bent in the region of the contact 40. The slot 61 is arranged centrally on the bolt 57. The sheet metal piece 58 extends from the second connector 68 of the diode 62 to the end facing toward the first contact 39. The first contact 39 and the second contact 40, which is formed on the sheet metal piece 58, thereby lie both in the region of the latch contour 64 (FIG. 17). The bolt 57, the diode 62 and the sheet metal piece 58 conjointly form a common component which is injection molded as a unit in the operating-mode position selector 55. The first contact 39, the second contact 40 and the ignition module connector 66 project out from the material of the operating-mode position selector 55 for making contact thereto. In lieu of the diode 62, a resistance or another electric component can be provided, for example, a capacitor or an inductive component or a combination of several components. Because of the electric component, there results a different voltage course which can be evaluated by a control electronics, especially, in the ignition module 37.

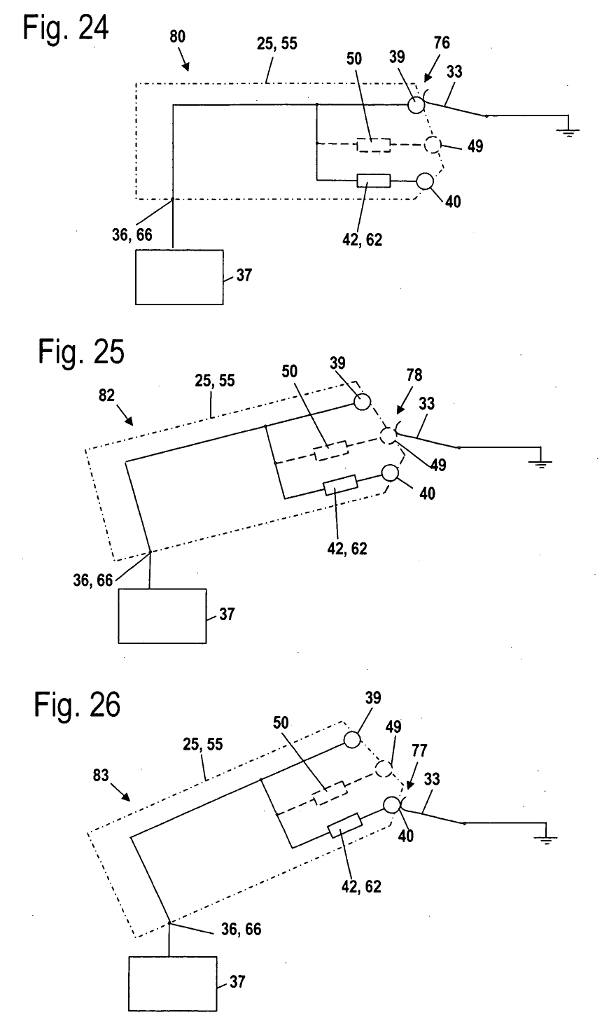

FIGS. 24 to 27 show the electric circuit on the operator-controlled shaft 25 and on the operating-mode position selector 55. A third contact 49 can also be provided on the operating-mode position selector 55 which is connected to the first contact 39 and to the ignition module connector 36 via a resistor 50 or another electric component. In the off position 80 shown in FIG. 24, a first switch 76, which is formed by the first contact 39 and the contact spring 33 is closed. In this way, the ignition module 37 is grounded via the contact spring 33. No ignition spark can be generated at the spark plug 52.

A third switch 78 is closed in the start position 82 of the operator-controlled shaft 25 and the operating-mode position selector 55 shown in FIG. 25. This switch is formed by the third contact 49 and the contact spring 33. In this position, the ignition module 37 is connected via resistance 50 to the ground connector. This can be evaluated by the control in the ignition module 37 and the start position 82 can be detected.

In the choke position 83 shown in FIG. 26, a second switch 77 is closed. This switch is formed by the contact 40 and the contact spring 33. The ignition module 37 is thereby connected to ground via the diode 42 or the diode 62. This can be evaluated by the control electronics of the ignition module 37 so that the choke position 83 can be detected by the ignition module 37 and, for example, the ignition time point can be correspondingly adjusted.

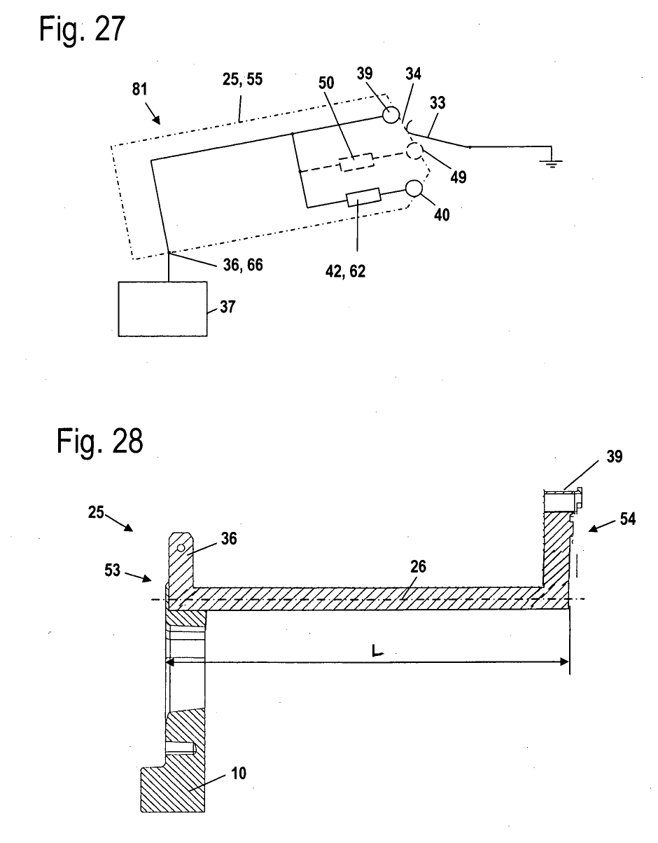

FIG. 27 shows the operating-mode position selector 55, that is, the operator-controlled shaft 25 in the operating position 81. In this position, the contact spring 33 lies against the latch contour 34 between the first contact 39 and the third contact 49. The ignition module 37 is not connected to ground. This too is correspondingly evaluated by the ignition module 37 so that also the operating position 81 can be detected. All switch states can be electronically detected from the suggested configuration of the operating-mode position selector 55 and the operator-controlled shaft 25. A corresponding control of the engine 7 can take place.

A simple shape of the operating-mode position selector results from the coating of the lines and the electric components. The coated components increase the stability and are, at the same time, well protected by the coating against vibrations and ambient influences such as contaminants and moisture. In this way, a long service life of the operating-mode position selector is obtained.

In FIG. 28, an embodiment of an operator-controlled shaft 25 is shown which is comprised essentially of a conductive material. The conductive material can be metal or a conductive plastic. The ignition module connector 36 and the first contact 39 are formed as one piece with the material of the operator-controlled shaft 25. A second contact 40 (not shown) is advantageously connected via an electric component to the operator-controlled shaft 25. The operator-controlled lever 10 is injection molded on the operator-controlled shaft 25 and advantageously comprises a non-conducting plastic. The operator-controlled lever 10 can be connected to the operator-controlled shaft 25 so as to be insulated with respect thereto and can likewise comprise a conductive material. The actuating cams 27 and 28 (not shown in FIG. 28) can likewise be configured as one piece with the operator-controlled shaft 25.

It is understood that the foregoing description is that of the preferred embodiments of the invention and that various changes and modifications may be made thereto without departing from the spirit and scope of the invention as defined in the appended claims.

What is claimed is:

1. A portable handheld work apparatus comprising:
an internal combustion engine having an ignition system;
a first switch having a first contact;
a second switch having a second contact;
an operating-mode position selector movable from a first position whereat said first switch is closed to a second position whereat said second switch is closed; and,
said first contact and said second contact being configured on said operating-mode position selector.

2. The portable handheld work apparatus of claim 1, wherein said operating-mode position selector consists of plastic and said first and second contacts are coated by the material of said operating-mode position selector.

3. The portable handheld work apparatus of claim 2, further comprising an electric component; and, said second contact being electrically connected to said first contact via said electric component.

4. The portable handheld work apparatus of claim 3, wherein said electric component is coated by the material of said operating-mode position selector.

5. The portable handheld work apparatus of claim 3, wherein said first contact, said second contact and said electric component conjointly form a common component coated by the material of said operating-mode position selector.

6. The portable handheld work apparatus of claim 3, wherein at least one of said contacts is formed on a sheet metal piece; and, said electric component is connected to said sheet metal piece via a bent-over lug formed on said sheet metal piece.

7. The portable handheld work apparatus of claim 2, further comprising a bolt coated by the material of said operating-mode position selector; and, at least one of said contacts being configured on said bolt.

8. The portable handheld work apparatus of claim 1, wherein said operating-mode position selector is pivotally mounted on said work apparatus.

9. The portable handheld work apparatus of claim 8, further comprising a conductor and at least one of said contacts being formed on said conductor; and, said conductor being coated by the material of said operating-mode position selector.

10. The portable handheld work apparatus of claim 9, further comprising a carburetor and said operating-mode position selector being configured as an operator-controlled shaft defining a rotational axis and having an axial length (L) corresponding at least to the width (b) of said carburetor measured parallel to said rotational axis of said operator-controlled shaft.

11. The portable handheld work apparatus of claim 10, wherein said conductor extends over approximately all of said length (L) of said operator-controlled shaft.

12. The portable handheld work apparatus of claim 10, said operator-controlled shaft having first and second ends; and, said apparatus further comprising an operator-controlled lever arranged in the region of said first end of said operator-controlled shaft; and, said first and second contacts being arranged in the region of said second end of said operator-controlled shaft.

13. The portable handheld work apparatus of claim 12, further comprising a connector arranged in the region of said first end of said operator-controlled shaft; and, said connector being formed on said conductor and projecting out of said material of said operator-controlled shaft.

14. The portable handheld work apparatus of claim 9, further comprising an electric component; and, said conductor being fixedly connected to said electric component and said contacts; and, said conductor defining a carrier structure of said operator-controlled shaft.

15. The portable handheld work apparatus of claim 9, wherein said conductor is a stamped conductor.

16. The portable handheld work apparatus of claim 3, wherein said electric component is a diode.

17. The portable handheld work apparatus of claim 3, wherein said electric component is a resistor.

18. The portable handheld work apparatus of claim 1, wherein said operating-mode position selector is at least partially made of an electrically-conducting material.

19. The portable handheld work apparatus of claim 1, wherein said switches include a contact spring coacting with said contacts.

20. The portable handheld work apparatus of claim 1, wherein said first switch is closed in an off position of said operating-mode position selector.

21. The portable handheld work apparatus of claim 1, wherein said second switch is closed in a choke position of said operator-controlled position selector.

22. The portable handheld work apparatus of claim 1, wherein said operating-mode position selector has a third contact; and, wherein said apparatus further comprises a third switch and said third contact is part of said third switch; said third switch is closed in the start position of said operating-mode position selector; and, said third contact is coated with the material of said operating-mode position selector.
